(19) United States
(12) Patent Application Publication
(10) Pub. No.: US 2020/0312485 A1
(43) Pub. Date: Oct. 1, 2020

(54) WIRE HARNESS

(71) Applicants: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP)

(72) Inventors: Takuya YAMASHITA, Yokkaichi (JP); Kazuo NAKASHIMA, Yokkaichi (JP); Takaaki HAMAGUCHI, Yokkaichi (JP)

(73) Assignees: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP)

(21) Appl. No.: 16/816,549

(22) Filed: Mar. 12, 2020

(30) Foreign Application Priority Data
Mar. 26, 2019 (JP) 2019-059069

(51) Int. Cl. H01B 7/02; H01B 7/00; H02K 11/33; H02K 5/22

(52) U.S. Cl. CPC H01B 7/0275; H01B 7/0045; H01R 11/12; H02K 5/225; H02K 11/33

(57) ABSTRACT

A wire harness according to an exemplary aspect of the disclosure includes a wire including a conductor and a covering that covers the conductor; and molds that are respectively provided at both ends of the wire, wherein: the covering is formed of a silicone rubber, and the covering covers the molds.

### BACKGROUND

The present disclosure relates to a wire harness.

JP 2016-126981A describes an automobile wire harness including a silicone coated wire, a metal terminal, and a mold portion that covers a connection portion between the silicone coated wire and the metal terminal, wherein the periphery of the connection portion is covered with a waterproof layer. In this document, the mold portion covers the covering member at an end portion of the silicone coated wire.

### SUMMARY

In general, for a wire harness, it becomes difficult to attach a wire in a bent state when the wire thickness is increased in order to support a high voltage. For this reason, a silicone rubber, which is flexible, has been used in place of a cross-linked polyethylene, which is hard, as the covering member of the conventional wire harnesses.

However, the silicone rubber that covers the silicone coated wire has already been hardened, and thus has poor adhesiveness. Therefore, it is difficult to secure the waterproofing performance between the covering member of the wire and the mold portion that covers the covering member by using a silicone rubber as it is. Although it is possible to use a method in which primer treatment, plasma treatment, or the like is performed in order to improve the adhesiveness of the silicone rubber, such a method complicates the production process of the wire harness.

An exemplary aspect of the disclosure provides a wire harness that exhibits good wire flexibility and good waterproofing performance between a covering member of a wire and a mold portion.

A wire harness according to an exemplary aspect of the disclosure includes a wire including a conductor and a covering that covers the conductor; and molds that are respectively provided at both ends of the wire, wherein: the covering is formed of a silicone rubber, and the covering covers the molds.

According to the present disclosure, it is possible to provide a wire harness that exhibits good wire flexibility and good waterproofing performance between a covering member of a wire and a mold portion.

### BRIEF DESCRIPTION OF THE DRAWINGS

FIG. 1 is a diagram illustrating an example of a representative configuration of a wire harness according to Embodiment 1;

FIG. 2 is a diagram schematically showing a cross section of a portion of the wire harness according to Embodiment 1 on a side of one mold portion;

FIG. 3 is a diagram schematically showing a cross section of a portion of the wire harness according to Embodiment 1 on a side of the other mold portion;

FIG. 4 is a diagram schematically showing a partial cross section of a wire harness according to Embodiment 2 on the other (one) mold portion side;

FIG. 5 is a diagram schematically showing a three-dimensional model used for flow analysis in experimental examples;

FIG. 6 is a diagram schematically showing a part of the result of flow analysis in the experimental examples; and

FIG. 7 is a diagram schematically showing the cavities of a mold that has been produced based on the result of flow analysis in the experimental examples.

### DETAILED DESCRIPTION OF EMBODIMENTS

### Description of Embodiments of the Present Disclosure

First, aspects of the present disclosure will be listed and described.

A wire harness according to the present disclosure includes: a wire including a conductor and a covering member that covers the conductor; and mold portions that are respectively provided at both ends of the wire, wherein the covering member is formed of a silicone rubber, and the covering member covers the mold portions.

In the wire harness according to the present disclosure, the covering member is formed of a silicone rubber, which has higher flexibility than a cross-linked polyethylene and the like. Accordingly, even when the wire thickness is increased in order to, for example, support a high voltage, the wire harness of the present disclosure can secure the flexibility of the wire, and therefore, the wire can be attached in a bent state. In the wire harness of the present disclosure, the covering member formed of a silicone rubber covers mold portions that are respectively provided at both ends of a wire. With this configuration, the surface of each of the mold portions respectively provided at both ends of a conductor and the surface of the conductor located between the mold portions are covered with an uncured silicone rubber, and thereafter the silicone rubber can be cured to form a covering member. Accordingly, the covering member formed of a silicone rubber can be bonded to the surfaces of the mold portions without the need to perform primer treatment, plasma treatment, or the like. Therefore, the wire harness of the present disclosure exhibits good waterproofing performance (including, not only the prevention of penetration of water, but also prevention of penetration of liquid such as oil; this description will be omitted in the following) between each of the mold portions and the covering member that covers the mold portions.

Thus, with the wire harness of the present disclosure, it is possible to obtain a wire harness that exhibits good wire flexibility and good waterproofing performance between a covering member of a wire and a mold portion. Note that the wire harness of the present disclosure includes a power cable.

In the wire harness of the present disclosure, it is possible to adopt a configuration in which the covering member has been formed through injection molding. With this configuration, it is possible to reliably secure the waterproofing performance provided through bonding between the covering member that covers a mold portion and the mold portion. This configuration also provides excellent formability of the covering member onto the conductor. Note that if the covering member has been formed through injection molding, the covering member includes, on any portion on the surface thereof, a gate mark, which is unique to injection molding. Accordingly, whether or not the covering member has been formed through injection molding can be determined by checking the presence or absence of a gate mark. Examples of the silicone rubber that forms the covering member include a liquid silicone rubber and a minable silicone rubber. The liquid silicone rubber is preferable as the silicone rubber in terms of the injection moldability, the flowability during injection molding, and the like.

The wire harness of the present disclosure may have a configuration in which the covering member includes, on a side of one of the mold portions, a vertical surface that is perpendicular to an axial direction of the wire, the covering member includes, on a side of the other mold portion, a taper-shaped portion that is inclined toward a surface of the conductor from the other mold portion, and the covering member includes a gate mark on the one mold portion side. With this configuration, even if a silicone rubber is passed from the one mold portion side toward the other mold portion side during injection molding, the silicone rubber can be sufficiently charged into an injection mold. One reason for this is that the covering member includes a vertical surface on the one mold portion side, and therefore, during injection molding, the silicone rubber can easily flow around the outer periphery of the mold portion first and then toward the conductor in front. Another reason is that the covering member includes a taper-shaped portion on the other mold portion side, and therefore, the flow of the silicone rubber is less likely to be obstructed during injection molding. Note that the term “perpendicular” as mentioned above means that the vertical surface is perpendicular to the axial direction of the wire, not in a geometrically strict sense, but in a broader sense in which the vertical surface can be considered as being perpendicular as long as the effects of the present disclosure can be achieved.

The wire harness of the present disclosure may have a configuration in which a length between the one mold portion and the other mold portion is 300 mm or less. With this configuration, it is possible to avoid an excessive increase in the wire length, and therefore an injection mold can be easily prepared. Furthermore, a wire harness that is suitable to transmit power can be obtained. The length between the one mold portion and the other mold portion may be preferably 290 mm or less. The length between the one mold portion and the other mold portion may be preferably 10 mm or more, or more preferably 50 mm or more. Note that each of the mold portions may be formed by a part of the connector housing, for example.

In the wire harness of the present disclosure, the wire may have a nominal cross-sectional area of 8 mm² or more. Since a silicone rubber is used as the covering member of the wire, the wire is more flexible and more easily bendable than when a material other than a silicone rubber, such as a cross-linked polyethylene, is used as the covering member. Accordingly, with the above-described configuration, the wire thickness is increased, and thus the wire can be bent even when a wire in the conventional wire harness cannot be bent. The nominal cross-sectional area of the wire may be preferably 12 mm² or more, more preferably 16 mm² or more, or even more preferably 20 mm² or more. In view of, for example, a limit to the degree to which the wire can be bent, the nominal cross-sectional area of the wire may be, for example, 120 mm² or less, or may be 100 mm² or less.

The wire harness of the present disclosure may include one wire described above, or may include a plurality of the wires. Preferably, the wire harness of the present disclosure includes three or more of the wires. When the number of the wires is three or more, the effect on the flexibility and the bendability of the wire harness is increased. With the above-described configuration, even if the number of the wires is three or more, it is possible to obtain a wire harness that is flexible and easily bendable. The number of the wires may be, for example, 10 or less, or may be 8 or less.

Each of the above-described mold portions may be formed of polyester or polyamide. With this configuration, the wire harness exhibits excellent formability of the mold portions through injection molding. Specifically, preferable examples of the polyester include polybutylene terephthalate (PBT). PBT is particularly preferable because of excellent heat resistance, material strength, weatherability, and the like thereof. Specifically, preferable examples of polyamide include various nylons. If necessary, polyester and polyamide may contain one or two or more additives such as glass fiber and a filler.

The wire harness of the present disclosure may be used to provide a connection between an inverter and a motor generator. When a connection is provided between an inverter and a motor generator in a vehicle such as an automobile, the wire harness is often attached in a bent state because of the vehicle layout. Therefore, according to the above-described configuration, the effects of the present disclosure can be sufficiently achieved.

The wire harness of the present disclosure may be configured to provide a connection between an inverter and a motor generator. Specifically, an architecture (may also be referred to as “structure”; the description thereof will be omitted in the following) of the present disclosure may include: the wire harness according to the present disclosure; an inverter; and a motor generator, wherein the wire harness of the present disclosure provides a connection between the inverter and the motor generator. With the architecture of the present disclosure, the wire harness of the present disclosure is disposed in a bent state, and thus, the effects of the present disclosure can be sufficiently achieved.

In the wire harness of the present disclosure, it is possible to adopt a configuration in which each of the mold portions has a groove portion on a surface thereof, and an interior of the groove portion is filled with a part of the covering member that covers the mold portion. With this configuration, the length of the interface between the covering member and the surface of the mold portion in a cross-sectional view along the axial direction of the wire is increased as compared with the case where the mold portion does not include the groove portion on the surface thereof. Accordingly, this configuration can improve waterproofing performance. The groove portion may be formed, for example, in the outer peripheral surface of an end of the mold portion. In this case, for example, the groove portion may be formed in an annual shape in the outer peripheral surface of an end of the mold portion, or may be formed in a part of the outer peripheral surface of an end of the mold portion. In the former case, the waterproofing performance at the end of the mold portion in the outer peripheral direction thereof can be easily improved. Note that the groove portion may be formed in only one of the mold portions, may be formed in only the other mold portion, or may be formed in both the one mold portion and the other mold portion.

In the wire harness of the present disclosure, it is possible to adopt a configuration in which each of the groove portions includes an undercut portion. With this configuration, even if the covering member is pulled upward of the groove portion, a part of the covering member is locked (caught) by the undercut portion of the groove portion, and therefore, the covering member is less likely to come off from the groove portion. Therefore, this configuration is advantageous in terms of improving waterproofing performance.

The wire harness of the present disclosure may further include a terminal that is connected to the conductor, wherein each of the undercut portions is disposed on the terminal side. With this configuration, even if air has reached the undercut portion when performing a leak test in which air is passed between the conductor and the covering member from the terminal side, the covering member beginning to be swollen by the air from the inside to the outside is held down by the undercut portion. Accordingly, with this configuration, an air leak from between each of the mold portions and the covering member can be easily suppressed. Therefore, this configuration can provide a wire harness that exhibits excellent waterproofing performance.

Specifically, each of the undercut portions may include an inclined surface having an angle of 85 degrees or less between the undercut portion and a bottom surface of the corresponding groove portion. With this configuration, the above-described effect through the provision of the undercut portion can be reliably achieved. The angle between the inclined surface and the bottom surface of the groove portion may be preferably 80 degrees or less, more preferably 75 degrees or less.

### Details of Embodiments of the Present Disclosure

Specific examples of the wire harness according to the present disclosure will be described below with reference to the drawings. It should be noted that the present disclosure is not limited to these examples.

### Embodiment 1

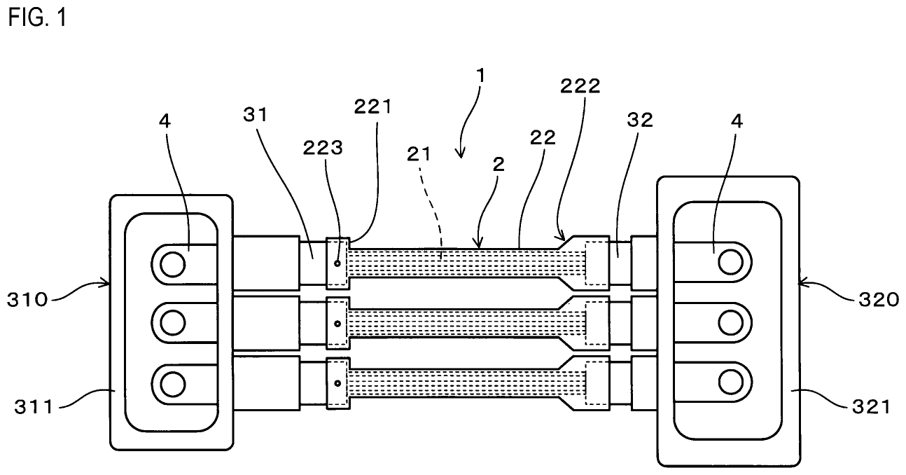

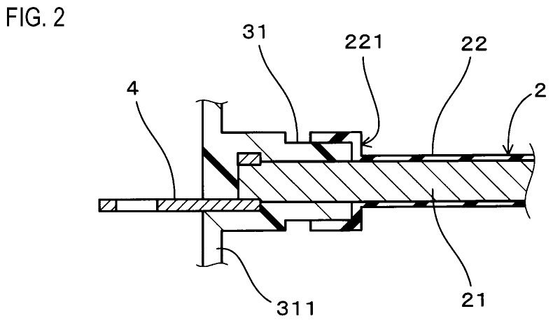

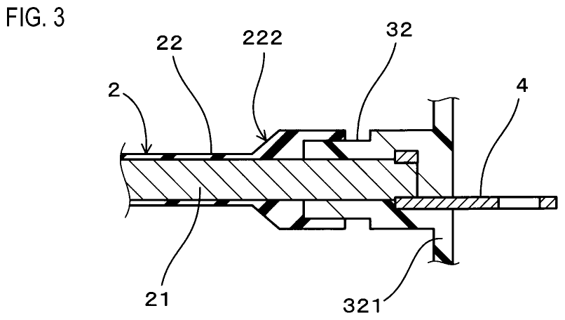

A wire harness according to Embodiment 1 will be described with reference to FIGS. 1 to 3. As illustratively shown in FIGS. 1 to 3, a wire harness 1 includes a wire 2 and mold portions 31 and 32 (molds). The wire 2 includes a conductor 21 and a covering member 22 (covering) that covers the conductor 21. The mold portions 31 and 32 are respectively provided at both ends of the wire 2. The covering member 22 is formed of a silicone rubber. The covering member 22 covers the mold portions 31 and 32.

Specifically, in the present embodiment, the wire harness 1 includes a plurality of wires 2. FIG. 1 shows an example in which three wires 2 are included. Each wire 2 has a nominal cross-sectional area of 8 mm² or more. The wire harness 1 further include terminals 4. The terminals 4 are connected to both end portions of the conductor 21. The mold portions 31 and 32 are respectively formed as parts of connector housings 310 and 320 made of PBT. Specifically, the connector housing 310 includes a hood portion 311 in which the terminals 4 are exposed, and mold portions 31 extending from the hood portion 311. Similarly, the connector housing 320 includes a hood portion 321 in which the terminals 4 are exposed, and mold portions 32 extending from the hood portion 321. In the wire harness 1, the length between each mold portion 31 and the corresponding mold portion 32 is 300 mm or less. The mold portions 31 and 32 are respectively provided at both ends of each of the conductors 21 to which the terminals 4 are connected, with distal end sides of the terminals 4 being exposed.

Specifically, the covering member 22 is formed by injection molding a liquid silicone rubber. The covering member 22 covers the outer peripheral surface of an end of each of the mold portions 31 and 32. That is, in the wire harness 1, both ends of each of the conductors 21 to which the terminals 4 are connected are respectively covered by the mold portions 31 and 32, and the covering member 22 is formed on the surface of the conductor 21 and the surface of each of the mold portions 31 and 32. The present embodiment shows an example in which each covering member 22 covers the corresponding mold portion 31 on the mold portion 31 side. Meanwhile, FIG. 1 shows an example in which the covering member 22 covers the corresponding mold portion 32. The mode of molding is not limited to FIG. 1. For example, a covering member 22 that covers a mold portion 31 may be integrated in one piece with a covering member 22 that covers an adjacent mold portion 31. More specifically, for example, two covering members 22 each covering a conductor 21 may be integrated in one piece with each other on the mold portion 31 side, or a plurality of, other than two, covering members 22 each covering a conductor 21 may be integrated in one piece with each other on the mold portion 31 side.

On the mold portion 31 side, each covering member 22 includes a vertical surface 221 that is perpendicular to the axial direction of the wire 2. Specifically, the vertical surface 221 is disposed on the conductor 21 side relative to an end face of the mold portion 31. Note that the vertical surface 221 may also be considered a vertical step. On the other hand, on the mold portion 32 side, each covering member 22 includes a taper-shaped portion 222 that is inclined toward the surface of the conductor 21 from the mold portion 32. The taper-shaped portion 222 is disposed on the conductor 21 side relative to an end face of the mold portion 32. The covering member 22 includes, on the mold portion 31 side, a gate mark 223 resulting from injection molding.

The wire harness 1 of the present embodiment is used to provide a connection between an inverter (not shown) and a motor generator (not shown) that are mounted on an automobile such as a hybrid car. That is, the wire harness 1 is used as a power cable. The wire harness 1 may be connected to the inverter on the mold portion 31 side thereof, and may be connected to the motor generator on the mold portion 32 side thereof. Alternatively, the wire harness 1 may be connected to the motor generator on the mold portion 31 side thereof, and may be connected to the inverter on the mold portion 32 side thereof.

### Embodiment 2

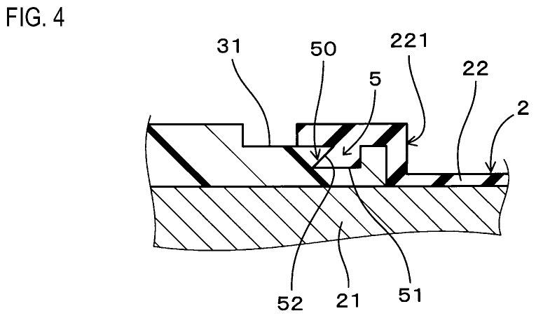

A wire harness according to Embodiment 2 will be described with reference to FIG. 4. The mold portion 31 includes a groove portion 5 (groove) on a surface thereof. The interior of the groove portion 5 is filled with a part of the covering member 22 that covers the mold portion 31. That is, a part of the covering member 22 is charged into the groove portion 5. Note that in the present embodiment, the groove portion 5 is formed in an annular shape in an outer peripheral surface of an end of the mold portion 31.

In the present embodiment, the groove portion 5 includes an undercut portion 50 (undercut). Specifically, the undercut portion 50 includes a bottom surface 51 of the groove portion 5 and an inclined surface 52 that is inclined relative to the axial direction of the wire 2. The bottom surface 51 of the groove portion 5 is parallel to the axial direction of the wire 2 in a cross-sectional view along the axial direction of the wire 2. Note that “parallel” as mentioned herein means that the bottom surface 51 of the groove portion 5 is parallel to the axial direction of the wire 2 in a cross-sectional view along the axial direction of the wire 2, not in a geometrically strict sense, but in a broader sense in which the bottom surface 51 can be considered as being parallel as long as the effects of the present disclosure can be achieved. The angle formed between the bottom surface 51 of the groove portion 5 and the inclined surface 52 is 85 degrees or less. The undercut portion 50 is disposed on the terminal 4 side (the right side in FIG. 4). That is, the undercut portion 50 is formed on a wall surface of the groove portion 5 that is located on the terminal 4 side.

Note that in the present embodiment, the other mold portion 32 also includes a groove portion configured in the same manner as that of the one mold portion 31 described above. The rest of the configuration is the same as that of Embodiment 1.

### EXPERIMENTAL EXAMPLES

To produce a mold for forming a covering member that covers all together the outer peripheral surface of an end of one mold portion, the outer peripheral surface of an end of the other mold portion, and the outer peripheral surface of the conductor between the molds, a covering material was subjected to the following flow analysis.

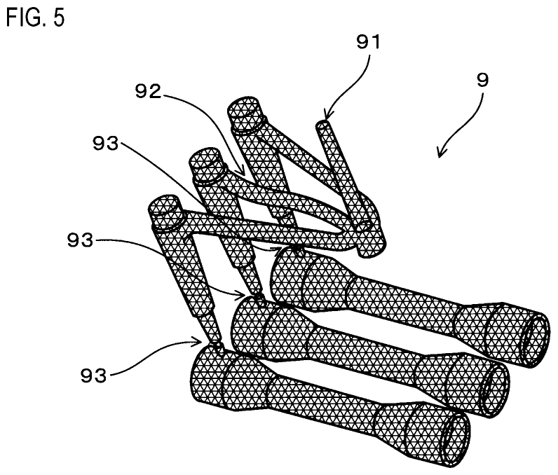

FIG. 5 shows a schematic three-dimensional model used for the flow analysis. In the three-dimensional model 9, a covering material that has been injected into an inlet 91 provided at one location flows through a runner portion 92 and reaches gate portions 93 provided at three locations. Then, the surfaces of each of the conductors, the outer peripheral surface of an end of each of the mold portions respectively provided at both ends of the conductor are covered all together by the covering material flowing into the mold from the gate portions 93. Also, with the three-dimensional model 9, covering members each including a taper-shaped portion are formed on the sides of the both mold portions. The conditions for the flow analysis were as follows: Material viscosity: 600 Pa·s, Mold surface temperature: 175° C., Temperature of covering material injected: 20° C., and Recommended curing temperature of covering material: 175° C.

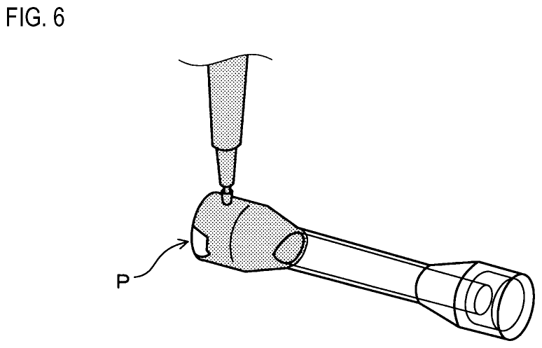

According to the result of the above-described flow analysis, when the gate portion side was formed in a tapered shape as shown in FIG. 6, the covering material flew to the conductor side in front before sufficiently covering the outer peripheral surface of an end of the mold portion. Thus, a portion into which the covering material had not been charged was formed at a part of the outer peripheral surface of an end of the mold portion on the gate portion side (indicated by the arrow P in FIG. 6).

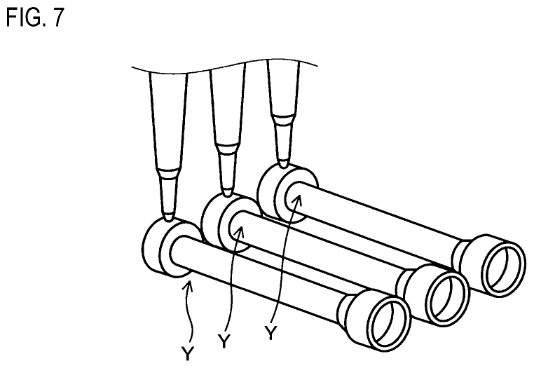

Based on the result of the flow analysis, a mold having cavities as shown in FIG. 7 was produced. In the mold shown in FIG. 7, the tapered shape on the gate portion side is thinned (indicated by the arrow Y in FIG. 7) as compared with that of the three-dimensional model shown in FIG. 5. With such a mold, it is possible to form a covering member that includes a vertical surface perpendicular to the axial direction of the wire on the one mold portion side, includes a taper-shaped portion inclined toward the surface of the conductor from the other mold portion on the other mold portion side, and includes a gate mark on the one mold portion side.

Using such a mold, a wire harness having the shape shown in FIG. 1 was produced. Specifically, terminals were respectively connected to both ends of each of three conductors made of a copper-based stranded wire. Then, a mold portion constituting a part of a connector housing was formed through insert molding on both end portions of each of the three conductors provided with the terminals. Note that each of the mold portions protrudes from a wall surface of a hood portion of the corresponding connector housing, as shown in FIG. 1. The material used for the connector housing was PBT. Then, each of the conductors provided with the mold portions was set in the above-described mold, and a liquid silicone rubber was injected into the mold, whereby a covering member was formed. The temperature of the liquid silicone rubber injected was 20° C., and the mold surface temperature was 175° C. “ELASTOSIL LR3370/40” manufactured by Wacker Asahikasei Silicone Co., Ltd. was used as the liquid silicone rubber. Thus, a wire harness of a sample 1 was produced.

As a result of visually checking the appearance of the obtained wire harness, a portion into which the liquid silicone rubber had not been charged was not observed on the outer peripheral surface of an end of each of the mold portions on the gate portion side of the mold. The reason for this is as follows: Since the wire harness had a configuration in which the covering member included a vertical surface on the gate portion side of the mold, the liquid silicone rubber had been sufficiently charged into a cavity located on the outer periphery of an end of the mold portion, and thereafter the liquid silicone rubber, which had nowhere to go, flew into a cavity located on the outer periphery of the conductor in front. Note that when the tapered shape is formed on the gate portion side, a portion into which the liquid silicone rubber has not been charged can also be eliminated by making adjustment such as increasing the gradient of the tapered shape, providing a gate portion on each of the mold portions, or further providing an additional gate portion.

For the obtained wire harness, a leak test was performed in order to evaluate the waterproofing performance between the mold portion and the covering member. Specifically, the wire harness was cut at a position located 30 mm toward the center of the conductor from the vertical surface of the covering member, and a position located 30 mm toward the center of the conductor from a distal end of the taper-shaped portion of the covering member. Air was supplied at 180 kPa from the hood portion of the connector housing of a specimen A including the vertical surface of the covering member, and the state of air leak was checked in water. Similarly, air was supplied at 180 kPa from the hood portion of the connector housing of a specimen B including the taper-shaped portion of the covering member, and the state of air leak was checked in water. As a result, both the specimen A and the specimen B did not show generation of air bubbles resulting from air leak for 90 seconds. This result has confirmed that it is possible to obtain a wire harness that exhibits excellent waterproofing performance between a mold portion and a covering member of a wire that covers the mold portion, while ensuring the flexibility of the wire by the covering member formed of a silicone rubber.

What is claimed is:

1. A wire harness comprising:
a wire including a conductor and a covering that covers the conductor; and
molds that are respectively provided at both ends of the wire, wherein:
the covering is formed of a silicone rubber, and
the covering covers the molds.

2. The wire harness according to claim 1, wherein the covering has been formed through injection molding.

3. The wire harness according to claim 1, wherein:
the covering includes, on a side of a first mold of the molds, a vertical surface that is perpendicular to an axial direction of the wire,
the covering includes, on a side of a second mold of the molds, a taper-shaped portion that is inclined toward a surface of the conductor from the second mold, and
the covering includes a gate mark on a first mold side.

4. The wire harness according to claim 1, wherein a length between the first mold and the second mold is 300 mm or less.

5. The wire harness according to claim 1, wherein the wire has a nominal cross-sectional area of 8 mm² or more.

6. The wire harness according to claim 1, wherein the wire includes three or more wires.

7. The wire harness according to claim 1, wherein each of the molds is formed of polyester or polyamide.

8. The wire harness according to claim 1, wherein the wire harness is used to provide a connection between an inverter and a motor generator.

9. The wire harness according to claim 1, wherein:
each of the molds has a groove on a surface thereof, and
an interior of the groove is filled with a part of the covering that covers the mold.

10. The wire harness according to claim 9, wherein each of the grooves includes an undercut.

11. The wire harness according to claim 10, further comprising:
a terminal that is connected to the conductor,
wherein each of the undercuts is disposed on a terminal side.

12. The wire harness according to claim 10, wherein each of the undercuts includes an inclined surface having an angle of 85 degrees or less between the undercut and a bottom surface of a corresponding groove.

13. An architecture comprising:
the wire harness according to claim 1;
an inverter; and
a motor generator,
wherein the wire harness provides a connection between the inverter and the motor generator.
